(19) United States
(12) Patent Application Publication
(10) Pub. No.: US 2011/0264243 A1
(43) Pub. Date: Oct. 27, 2011

(54) Method of Control for a Process Control System, and Control System for Controlling an Industrial Process

(76) Inventors: Ulrich Kunze, Bubenreuth (DE); Denis Schroff, Eggenstein-Leopoldshafen (DE); Horst Walz, Straubenhardt (DE)

(21) Appl. No.: 12/673,352

(22) PCT Filed: Aug. 12, 2008
(86) PCT No.: PCT/EP2008/060595

§ 371 Date: Jun. 30, 2011

(30) Foreign Application Priority Data
Aug. 14, 2007 (DE) 10 2007 038 372.1

(51) Int. Cl. G05B 13/04

(52) U.S. Cl. 700/30

(57) ABSTRACT

A method of control for a process control system and an appropriate control system is provided. Model calculations are integrated into the process control system such that the setpoint values calculated using the model calculations are processed further like measured values in the process control system, and control commands are derived from the measured values and/or setpoint values. The model calculations are integrated into the process control system using an adaptation program. The adaptation program includes program code and associated data from the model calculations and, in comparison with the other program components of the process control systems, is designed like a program component of the process control system. Within the adaptation program, the interfaces of the adaptation program match those of the model calculations.

### CROSS REFERENCE TO RELATED APPLICATIONS

This application is the US National Stage of International Application No. PCT/EP2008/060595, filed Aug. 12, 2008 and claims the benefit thereof. The International Application claims the benefits of German application No. 10 2007 038 372.1 EP filed Aug. 14, 2007. All of the applications are incorporated by reference herein in their entirety.

### FIELD OF INVENTION

The invention relates to a method of control for a process control system whereby measured values are obtained from the process to be controlled and integrated into the process control system in the model calculations, and to a control system for controlling an industrial process using software.

### BACKGROUND OF INVENTION

Process control systems are generally used in large-scale industrial installations, such as power stations or other technical plants with a high level of automation. These are used to monitor the largely automatic process and to display, control and regulate it in various ways and therefore form the interface between man and the industrial process.

As a rule, a control system is made up of software and hardware at various process levels.

At field level, measured values are obtained using sensors in the field units. The measured values then undergo further processing in signal processing units at automation level; these are then generally transferred by means of a bus system to mainframe computers such as an application server and automation server, where the data of this kind generated is processed for the highest level with its operating and user interfaces.

Theoretical calculations such as thermodynamic model calculations for operation of power stations are used in addition to the measured values in process automation, in order to identify weak points and to facilitate enhanced forecasts for the control of the large-scale installation for example.

It is the norm for model calculations of this kind to be implemented as stand-alone software modules over and above the software in the process control system. The stand-alone model calculation module receives measured values from the process control by way of a data link and uses them to calculate setpoint values upon the basis of the theoretical model implemented. These setpoint values are analyzed by the operator and may result in manual intervention into the automated process. The setpoint values calculated in this way are generally compared with the measured values in dedicated displays. In many cases, a second screen may even be used for this purpose.

However, it would be preferable for the foreman or for the manager of an industrial installation for the data calculated to be fed into the control automatically in such a way that the measured data for the process control system and the data calculated are displayed and subjected to further processing in a consistent manner.

### SUMMARY OF INVENTION

The object of the invention is therefore to specify a method of control for a process control system, which facilitates improved use of the results of the calculation. Another object of the invention is to specify a control system appropriate for controlling an industrial process.

These objects are achieved by a method with the features set down in the claims and a control system with the features set down in the claims.

The invention integrates model calculations into the process control system in order to achieve enhanced control functionality in a process control system whereby measured values are received on an ongoing basis from the process to be controlled. The setpoint values calculated using the model calculations are processed in the process control system as measured values. Further processing is defined in this context as verification of the setpoint value (e.g. in the form of a comparison with a measured value) in order to generate a control command or alarm command. Storage in a common data archive or display in a common process image is defined as further processing. Setpoint values must therefore be analyzed automatically in exactly the same way as measured values; this will then result in control commands being generated automatically in the process control system. This provides a number of benefits. In addition to the enhanced control functionality, the setpoint values can be displayed in conjunction with measured values in process and characteristic images. The setpoint values can be stored in the same process data archive as the measured values and accessed for later analyses in conjunction with stored measured values. The setpoint values can also be used to generate messages in the process control system; these messages can also be sorted chronologically according to their date of generation and displayed with other process messages.

An adaptation program is used to integrate model calculations into the process control system. In this version, the adaptation program includes the program code and associated data from the model calculations, which means that externally, i.e. in relation to other program components in the process control system, the model calculations take the form of a program component in the process control system and that internally, i.e. within the adaptation program, all of the interfaces match those in the model calculations. The benefit of this procedure is that the program code for the model calculations is incorporated unchanged into a program code in the process control system. One example of an adaptation program is the wrapper system, which can be used to incorporate new information systems, such as model calculations, into existing program code.

One advantageous embodiment version of the invention has the program code and associated data from the model calculations embedded in a program component in the process control system. The program component in question is a process periphery for timed processing of calculation functions, which has the same interfaces as the other program components, whereby bidirectional data transfer is defined as an interface. This adds a program component to the familiar program components, which, for all that it includes new content (i.e. the model calculations), has a structure already familiar to the system. The compatibility of the interfaces in all of the components facilitates improved communication and interaction between the program components.

In another embodiment version, the program code and associated data from the model calculations take the form of new program components in the process control system, whereby the interfaces in the model calculations are adjusted in accordance with the model calculations. This has the advantage of making it possible for adjustments to be made as required to the software in the control system.

Advantageous developments of the invention are shown in the sub-claims.

### BRIEF DESCRIPTION OF THE DRAWINGS

The invention is explained in more detail with the aid of an exemplary embodiment, in which;

FIG. 1 shows a diagram of a program component of a control system with integrated model calculations

### DETAILED DESCRIPTION OF INVENTION

An exemplary embodiment describes how to embed a program module with thermodynamic calculations into a program component of a control system in a power station.

Thermodynamic model calculations are used in the power station in order to identify weak points which affect energy consumption significantly. The measured data recorded in the field level, such as external temperature or fuel quality, for example, are entered into the model calculations as input variables. The way in which the plant is implemented in terms of engineering processes and procedures, for example, is stored in the model calculations. If the current ambient conditions recorded are entered into the model, it is possible to calculate the energy currently generated as a setpoint value. In accordance with the invention, this setpoint value is now treated in the same way as a measured value, since the model calculation module is integrated into a program component of the control system. The results of the thermodynamic model calculations can now be used in the process control system in the control functions for the power station process, e.g. it is possible to enter upon an automatic refinement process if the actual value varies from the setpoint value calculated for the heat transfer properties of a heat exchanger.

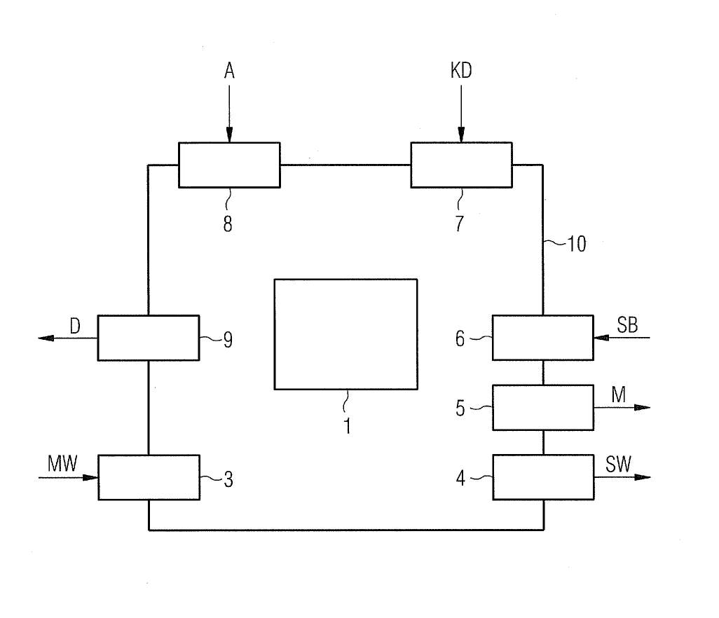

FIG. 1 is intended to illustrate how the module used in the model calculations is embedded. FIG. 1 takes the form of a diagram showing a “run time container” 10. The term “run time container” is used in a software program to designate the process periphery for time-managed processing of function modules. A function module is a calculation procedure conducted in conjunction with an automation process for a given function (e.g. opening of a valve).

Module 1 “thermodynamic calculations” is embedded in runtime container 10. The “wrapper” system is one example of the methods which can be used for the embedding process. In the wrapper system, a program code and its associated data are enclosed or encapsulated in another program. The wrapper, i.e. the enclosing program, acts as an interface between the program code enclosed and the program code which makes the request. The code enclosed may therefore even exhibit another programming language. The wrapper therefore performs the function of an adaptation program. In principle, any program which fulfils an adapter function can be used here: externally, i.e. in relation to other program components in the process control system, the adaptation program takes the faun of a program component in the process control system and exhibits for example the same data transfer interfaces as the other program components. Internally, i.e. within the adaptation program, on the other hand, all of the interfaces are matched to the model calculations.

In the exemplary embodiment of the invention illustrated in FIG. 1, runtime container 10 is used as a wrapper for calculation module 1. This produces a “container” for technological calculations, which is able to conduct all of the calculations in the calculation module and to pass the results of the calculations to other containers or program sections as appropriate.

Once the module for thermodynamic model calculations has been embedded into a component of the process control system (here: the container for technological calculations), component 10 can now communicate with other program components by way of standard interfaces.

For example, program component 10 obtains measured values MW by way of interface 3. The results of the model calculations are made available to other components of the process control system in the form of setpoint values SW by way of interface 4; these can then be input as measured values MW by way of their interface 3. Messages M can be transmitted to the message system in the process control system by way of interface 5. Service and control commands SB are received from program component 10 by way of interface 6. Program component 10 is configured by way of interface 7, using configuration data KD. Interface 8 can be used to launch, close down program component 10 or to vary its mode of operation. Diagnostics data D is read by way of interface 9. The diagnostics data takes the form of data on the states of the calculation module, for example messages such as: “Calculation in progress”, “Setpoint values are outside a control interval”.

The setpoint values generated in the container for technological calculations are now available to all program components (and other program sections) in the control system.

As an alternative to the wrapper system or to the use of an adaptation program, the model calculations can also be integrated into the process control system as a dedicated, new container type. This will require research into the interfaces in the model calculation and development of the use of these interfaces in the process control system. This will result in a new container type specifically matched to the model calculation in question being produced for every new model calculation. This eliminates the adapter/wrapper which provides an image of a special model calculation on a familiar container type.

1.-10. (canceled)

11. A method of control for a process control system, comprising:
obtaining a plurality of measured values of the process to be controlled;
verifying the plurality of measured values in the process control system;
deriving control commands from the plurality of measured values; and
integrating model calculations into the process control system,
wherein a plurality of setpoint values, calculated using the model calculations, are further processed in the process control system as measured values, and
wherein the control commands are derived automatically from the plurality of setpoint values following the verification of the plurality of setpoint values in the process control system.

12. The method as claimed in claim 11,
wherein an adaptation program is used to integrate the model calculations into the process control system, and
wherein the adaptation program includes a program code and associated data from the model calculations,
wherein the adaptation program, in relation to other program components of the process control system, is embodied as a program component of the process control system, and
wherein a first plurality of interfaces of the adaptation program are adapted to a second plurality of interfaces for the model calculations.

13. The method as claimed in claim 11,
wherein the program code and associated data from the model calculations are embedded into the program component of the process control system,
wherein the program component takes a form of a process periphery for timed processing of calculation functions and exhibits the same interfaces as the other program components, and
wherein a bidirectional data transfer is defined as an interface, whereby the program code for the model calculations is incorporated unchanged into a further program code in the process control system.

14. The method as claimed in 11, wherein the program code and associated data from the model calculations take the form of new program components in the process control system, whereby the second plurality of interfaces for the model calculations are adjusted to the model calculations.

15. The method as claimed in claim 11,
wherein the model calculations take the form of thermodynamic calculations for a power generation process, and
wherein the process control system takes the form of a control system for process automation in power stations.

16. A control system for optimized management of an industrial process, comprising:
a plurality of measured values included from the industrial process to be controlled;
a plurality of control commands; and
a plurality of setpoint values calculated from model calculations,
wherein the plurality of measured values are verified,
wherein the plurality of control commands are derived from the plurality of measured values using software,
wherein the software includes a program component into which a model calculation module is integrated in such a way that the plurality of setpoint values are subjected to further processing in the control system and handled as measured values, and
wherein following the verifying of the plurality of setpoint values in the control system, control commands are derived automatically from the plurality of setpoint values.

17. The control system as claimed in claim 16, wherein a means for embedding the program code and associated data from the model calculations is included, so that the program code and associated data from the model calculations are incorporated unchanged into the program component of the control system.

18. The control system as claimed in claim 17,
wherein the means for embedding the program code and associated data from the model calculations takes a form of an adaptation program which includes the program code and associated data from the model calculations,
wherein externally the adaptation program takes the foam of the program component in the process control system, and
wherein internally the adaptation program is adapted to the model calculations.

19. The control system as claimed in claim 18, wherein the program component takes the form of a process periphery for timed processing of calculation functions and exhibits the same interfaces as the other program components, whereby bidirectional data transfer is defined as an interface.

20. The control system as claimed in claim 16, wherein a new program component is created for the control system, whereby a plurality of interfaces in the model calculations are adjusted in accordance with the model calculations and a bidirectional data transfer is defined as the interface.
